(19) United States
(12) Patent Application Publication
(10) Pub. No.: US 2019/0041603 A1
(43) Pub. Date: Feb. 7, 2019

(54) Selfie Mirror For Smartphones

(71) Applicant: Harald Richter, Engelsbrand (DE)

(72) Inventor: Harald Richter, Engelsbrand (DE)

(21) Appl. No.: 15/806,705

(22) Filed: Nov. 8, 2017

(30) Foreign Application Priority Data
Aug. 3, 2017 (DE) 20 2017 004 039.5
Oct. 27, 2017 (DE) 20 2017 005 608.9

(51) Int. Cl. G02B 7/182; H04M 1/215

(52) U.S. Cl. CPC G02B 7/182; H04M 1/215

(57) ABSTRACT

A selfie mirror for smartphones includes a combination of a mirror and a ferromagnetic metal plate arranged therebelow and connected to the mirror, as well as means for fixing the arrangement comprised of the mirror and the ferromagnetic metal plate to a smartphone or a smartphone case. The mirror and the metal plate may be mechanically connected to each other by means of an adhesive foil or adhesive layer arranged therebetween, or they may be mechanically held together and/or enclosed by a frame surrounding them around their periphery.

This patent application claims the priority of German Patent Applications Nos. 20 2017 004 039.5, filed Aug. 3, 2017, and 20 2017 005 608.9, filed Oct. 27, 2017, both of which are incorporated by reference herein in their entirety.

The invention relates to a selfie mirror that may be attached to smartphones or sleeves for smartphones.

### BACKGROUND

Because the camera and the flash light are usually located on the back of a smartphone, and on smartphones that also have a front camera the rear camera is usually much better, selfie mirrors are used in order to achieve a better orientation of the smartphone without looking at the screen when taking pictures.

Self-adhesive mirrors that can be attached to the smartphone, as well as smartphone sleeves with selfie mirrors already attached to them, as well as selfie mirrors that may be attached to a selfie stick or plugged onto the edge of a smartphone for use, are already known in prior art.

### SUMMARY

In contrast, it is an object of the invention to create a selfie mirror with additional benefits. This object is achieved according to the invention by the arrangement defined in claim 1. Advantageous embodiments are the subject matter of the dependent claims.

The selfie mirror according to the invention is combined with a metal plate, so that the selfie mirror attached to a smartphone may not only be used as such, but also allows the smartphone to be fixed to any magnetic holder.

The selfie mirror according to the invention may have a self-adhesive configuration to be glued to a smartphone or a smartphone case, or it may be integrated into a smartphone or a smartphone sleeve, or it may be integrated into a handle bar that may be attached to or disposed on the back of the smartphone.

### BRIEF DESCRIPTION OF THE DRAWINGS

Some example embodiments are described below with reference to the accompanying drawings, in which:

FIG. 1 shows a selfie mirror having a circular configuration in a perspective view;

FIG. 2 shows an enlarged partial section through the selfie mirror according to the invention;

FIG. 3 shows section similar to FIG. 2 through an embodiment wherein the mirror is formed by a reflecting surface of a ferromagnetic metal plate, and

FIG. 4 schematically shows an embodiment wherein the selfie mirror has a frame connected to a smartphone or smartphone housing via a hinge joint.

### DETAILED DESCRIPTION

FIG. 1 shows a selfie mirror according to the invention in a perspective view. Here the frame 1 and the upper side of the mirror 2 can be seen.

FIG. 2 shows a section through an edge area of the selfie mirror according to FIG. 1. It consists of a frame 1 which can be made of plastics and extends around the periphery of the components and holds them together, a mirror 2, an adhesive foil or adhesive layer 3 arranged on the lower side thereof, a ferromagnetic metal plate 4 connected to the mirror 2 by means of the adhesive foil or adhesive layer 3, and a self-adhesive foil or adhesive layer 5 on the lower side of the metal plate 4 which is used to attach the selfie mirror to the smartphone. The adhesive layer 3 can be omitted if frame 1 holds the parts together mechanically.

FIG. 3 shows another embodiment of a selfie mirror according to the invention, in a section similar to FIG. 2, wherein the mirror 2 combined with the ferromagnetic metal plate 4 is formed by a high-gloss polished reflecting surface of the metal plate 4. In this design also, a frame 1 surrounding the ferromagnetic metal plate 4 may be provided, and a self-adhesive foil or self-adhesive layer 5 may also be provided on the underside of the metal plate 4 in this design, too.

In both of the described designs according to FIGS. 1 to 3, the combination of mirror 2 and metal plate 4 may be connected to the smartphone or the smartphone sleeve, as an alternative to using a self-adhesive layer or self-adhesive film 5 on the lower side of the metal plate 4 by gluing, welding or one-piece design of the frame 1 on the smartphone housing or a smartphone sleeve. The mirror/metal plate combination is then held in place by the frame 1.

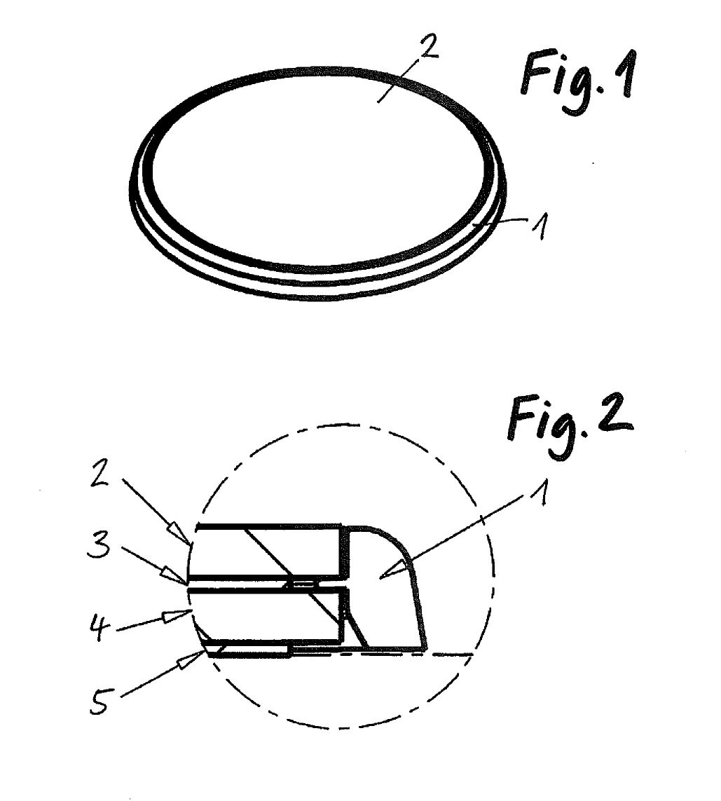

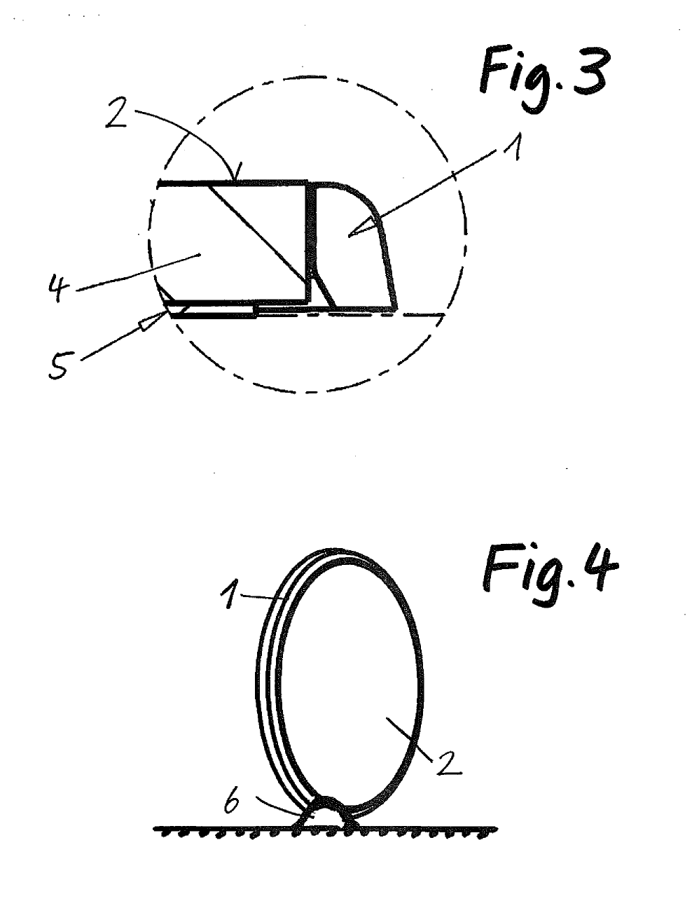

FIG. 4 schematically shows that a frame 1 holding the mirror/metal plate combination 2, 4 may be pivotably mounted on the smartphone or on the smartphone sleeve by means of a hinge connection 6, so that the selfie mirror can be pivoted into any desired position relative to the smartphone.

The embodiments shown in the drawings are of exemplary nature only. The point substantial to the invention is the combination of the mirror 2 with a metal plate 4 arranged therebelow, wherein the connection between the mirror 2 and the metal plate 4 may be effected in any desired way. The frame 1 may also be part of a handle bar that may be attached to a smartphone or may be configured integrally therewith.

It will be appreciated that the embodiments described above and shown in the drawings are merely exemplary in nature and that individual elements may also be combined differently than shown in these exemplary embodiments.

1. A selfie mirror for smartphones comprising a combination of a mirror and a ferromagnetic metal plate arranged therebelow and connected to the mirror, as well as means for fixing the arrangement comprised of the mirror and the ferromagnetic metal plate to a smartphone or a smartphone case.

2. The selfie mirror according to claim 1, wherein the mirror and the metal plate are mechanically connected to each other by means of an adhesive foil or adhesive layer arranged therebetween.

3. The selfie mirror according to claim 2, wherein the mirror and the metal plate are mechanically held together and/or enclosed by a frame surrounding them around their periphery.

4. The selfie mirror according to claim 1, wherein the mirror is part of the ferromagnetic metal plate and is formed by a high-gloss polished reflecting surface thereof.

5. The selfie mirror according to claim 4, wherein the ferromagnetic metal plate is held and/or enclosed by a frame surrounding it around its periphery.

6. The selfie mirror according to claim 3, wherein the frame is an integral part of a smartphone housing or a smartphone sleeve.

7. The selfie mirror according to claim 3, wherein the frame is part of a handle bar which may be attached to a smartphone or a smartphone sleeve or integrally formed therewith.

8. The selfie mirror according to claim 3, wherein the frame is pivotably connected to a smartphone or a smartphone sleeve, or to the handle bar, via a hinge connection.

9. The selfie mirror according to claim 5, wherein the frame is an integral part of a smartphone housing or a smartphone sleeve.

10. The selfie mirror according to claim 5, wherein the frame is part of a handle bar which may be attached to a smartphone or a smartphone sleeve or integrally formed therewith.

11. The selfie mirror according to claim 5, wherein the frame is pivotably connected to a smartphone or a smartphone sleeve, or to the handle bar, via a hinge connection.

12. The selfie mirror according to claim 7, wherein the frame is pivotably connected to a smartphone or a smartphone sleeve, or to the handle bar, via a hinge connection.

13. The selfie mirror according to claim 10, wherein the frame is pivotably connected to a smartphone or a smartphone sleeve, or to the handle bar, via a hinge connection.
